(19) United States
(12) Patent Application Publication
(10) Pub. No.: US 2018/0268446 A1
(43) Pub. Date: Sep. 20, 2018

(54) CUSTOMER ASSISTANCE SYSTEM

(71) Applicant: Walmart Apollo, LLC, Bentonville, AR (US)

(72) Inventors: Nicholaus A. Jones, Fayetteville, AR (US); Alvin Scott Taulbee, Springdale, AR (US); Jeremy Tingler, BENTONVILLE, AR (US)

(21) Appl. No.: 15/922,124

(22) Filed: Mar. 15, 2018

Related U.S. Application Data
(60) Provisional application No. 62/471,513, filed on Mar. 15, 2017.

(51) Int. Cl. G06Q 30/02; G06K 19/073; H04L 29/08

(52) U.S. Cl. CPC G06Q 30/0281; G06K 19/0723; H04L 67/18; G06K 19/07327

(57) ABSTRACT

Embodiments relate to customer assistance request systems and methods. A customer assistance request system generally includes at least one customer assistance kiosk including a radio frequency identification (RFID) tag, an RFID reader and a communication system. The RFID reader is configured to read the RFID tag number when a customer assistance kiosk is in an open configuration and the RFID tag is exposed. The communication system is configured to receive the read RFID tag number and issue a notification including the location of the at least one customer assistance kiosk.

### RELATED APPLICATION

The present application claims the benefit of U.S. Provisional Application No. 62/471,513 filed Mar. 15, 2017, which is hereby incorporated herein in its entirety by reference.

### TECHNICAL FIELD

Embodiments relate generally to methods and systems for improving customer assistance, particularly in large retail store settings. More particularly, embodiments relate to a customer assistance system and method, which includes the use of a kiosk that can be readily positioned and moved on the sales floor of a retail store, for registering and transmitting a request for assistance from a customer. The request for assistance inherently includes the location of the kiosk (and position of the requesting customer) on the sales floor.

### BACKGROUND

Successful retail store operations must increasingly rely on good customer service to distinguish themselves from competing stores, and, in particular, from alternative sales channels, such as internet marketing operations. At the same time, brick and mortar based businesses are under pressure, from the same alternative sales channels, to reduce overhead costs, which when reduced can have a direct, dilatory effect on customer service and the in-store experience.

One approach to providing customer service has been to provide fully staffed customer service counters or assistance centers. Another approach is to provide customer assistance kiosks. A customer can pick up a handset or press a button to engage an intercom, and establish a direct communication link to an associate/employee of the retail store. Such an approach, however, entails undue infrastructure costs, including power and set locations. Moreover, using such a system ignores the sales value of having a direct, face-to-face communication between the customer and an associate/employee of the store.

Wireless communications systems have also been deployed, in the effort to provide timely customer assistance, but such an approach is equipment dependent and expensive to operate in terms of power, infrastructure and maintenance. Wireless systems have proven particularly difficult to manage and administer in settings that cover large areas, requiring the equipment and expense of a complex network of routers and beacons.

Whatever the conventional communications system employed by a retail store for assisting in customer service might be, the system can require integration with other location systems in the store, in order to establish a link between a requesting customer and appropriate personnel. This, too, can be complicated and expensive.

A low cost, reliable, simple to operate and maintain customer assistance system, that includes a customer interface easily positioned and readily relocated on the sales floor, and that had the capability of being integrated into existing communication systems accessible from the sales floor of a retail operation, without the need for providing power to the customer interface would provide decided advantages to the retail customer experience.

### SUMMARY

Embodiments relate to customer service assistance kiosks that utilize radio frequency identification (RFID) to communicate customer assistance requests. In one embodiment, the present disclosure provides a customer assistance request system for use in or proximate to a retail space. The customer assistance request system can include at least one customer assistance kiosk, an RFID reader, and a communication system. The at least one customer assistance kiosk can include a housing and an RFID tag. The housing can have an open configuration and a closed configuration. In the closed configuration, the housing can form a Faraday cage. The RFID tag can have an RFID tag number arranged in the housing, such that the RFID tag is exposed free of the Faraday cage when the housing is in the open configuration. The RFID reader can be configured to read the RFID tag number from the RFID tag, when the housing is in the open configuration and the RFID tag is exposed free of the Faraday cage. The communication system can be communicatively coupled with the RFID reader and can be configured to: receive the read RFID tag number from the RFID reader, identify a location of the customer assistance kiosk corresponding to the read RFID tag number, and issue a notification comprising the identified location of the at least one customer assistance kiosk comprising the read RFID tag number.

In one embodiment, the present disclosure provides a method for identifying when and where a retail customer needs assistance in or proximate to a retail space. The method can comprise: providing at least one customer assistance kiosk in or near the retail space, the at least one customer assistance kiosk comprising a housing having an open configuration and a closed configuration, the housing forming a Faraday cage in the closed configuration, and a radio frequency identification (RFID tag having an RFID tag number and being arranged in the housing such that the RFID tag is exposed free of the Faraday cage when the housing is in the open configuration; arranging at least one RFID reader in or near the retail space; reading, by the at least one RFID reader, the RFID tag number from the RFID tag when the housing is in the open configuration and the RFID tag is exposed free of the Faraday cage; receiving, by a communication system communicatively coupled with the RFID reader, the read RFID tag number from the RFID reader; identifying, by the communication system, a location of the customer assistance kiosk corresponding to the read RFID tag number; and issuing, by the communication system, a notification comprising the identified location of the at least one customer assistance kiosk comprising the read RFID tag number.

The above summary is not intended to describe each illustrated embodiment or every implementation of the subject matter hereof. The figures and detailed description that follow more particularly exemplify various embodiments.

### BRIEF DESCRIPTION OF THE DRAWINGS

Subject matter here of may be more completely understood in consideration of the following detailed description of various embodiments in connection with the accompanying figures.

FIG. 1 is a schematic view of a customer assistance kiosk in a closed configuration, according to an embodiment.

FIG. 2A is a schematic view of a customer assistance kiosk in an open configuration, according to an embodiment.

FIG. 2B is a schematic view of a customer assistance kiosk in an open configuration, according to another embodiment.

FIG. 3 is a schematic view of an RFID reader, according to an embodiment.

FIG. 4 is a schematic view of a retail space including a customer assistance request system, according to an embodiment.

FIG. 5 is a flow chart of an embodiment of a method of identifying when and where a retail customer needs assistance in or proximate to a retail space.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

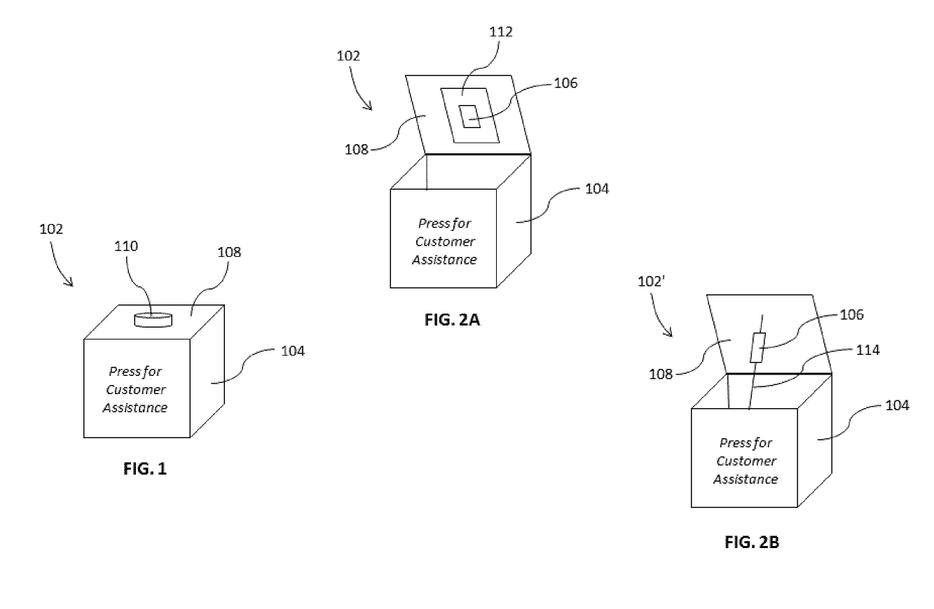

Referring to FIGS. 1-2B, a customer assistance kiosk 102 is depicted. The customer assistance kiosk 102 can include a housing 104 and a radio frequency identification (RFID) tag 106 mounted therein. The housing 104 can be configured to transition between an open configuration and a closed configuration. FIG. 1 depicts the housing 104 in a closed configuration, while FIGS. 2A-B depict the housing 104 in an open configuration.

Housing 104 can be constructed so as to form a Faraday cage or enclosure, at least in a closed configuration, so as to at least partially block or inhibit the flow of electrical fields and/or electromagnetic radiation therethrough. In one embodiment, housing 104 is at least partially constructed of an electrically conductive metallic material. In one embodiment, housing 104 is at least partially constructed of a mesh material.

In one embodiment, housing 104 can be configured as a six sided container, such as a box, having a lid 108. Other configurations for housing 104, such as cylinders, spheres, and various polygon arrangements are also contemplated. The lid 108 can be configured to be moved to an open position by a customer when assistance is needed, thereby transitioning the housing 104 from the closed configuration, to the open configuration. In one embodiment, the housing 104 is in the open configuration when the lid 108 is in the open position, and the housing 104 is in the closed configuration when the lid 108 is in the closed position. Moving between the open and closed positions can include causing the lid to rotate, slide, pivot, separate (e.g., in an embodiment in which the lid 108 comprises two or more portions that can move apart from one another), or otherwise actuate to cause the RFID tag 106 to be exposed outside of or within the housing 104. In other embodiments, the housing 104 or a portion thereof can be actuated relative to the lid 108, rather than the lid 108 being actuated whether to the housing 104.

In one embodiment, a customer can manually move the lid 108 to the open position by either gripping a portion of the lid 108 itself, or a handle operably coupled thereto. In another embodiment, a customer can transition the lid 108 to the open position by pushing a pushbutton 110 on the customer assistance kiosk 102. The pushbutton 110 can activate a mechanism to move the lid 108 from the closed position to the open position. The pushbutton 110 also can activate a mechanism to cause the RFID tag 106 to be exposed outside of the housing 104 in some other way, as appreciated by those of ordinary skill in the art.

The RFID tag 106 can have an RFID tag number, and can be arranged in the housing 104 such that the RFID tag 106 is exposed free of the Faraday cage when the housing 104 is in the open configuration. Accordingly, in the open configuration, the RFID tag 106 can be exposed to electromagnetic radiation, thereby enabling the RFID tag 106 to be “seen” and/or read by an RFID tag reader. The RFID tag 106 does not require its own electrical power source to be read by the RFID tag reader.

The RFID tag 106 can be mechanically coupled to the lid 108, such that the RFID tag 106 moves from a first position when the lid is closed, to a second position when the lid 108 is in the open position. As depicted in FIG. 2A, in one embodiment, a neutral dielectric material 112, or other insulator, is operably coupled to the lid 108, and the RFID tag 106 is operably coupled to the dielectric material 112. As depicted in FIG. 2B, in another embodiment, the RFID tag 106 is suspended from the lid 108 from a flexible string or cord 114, thereby pulling the RFID tag 106 away from the interior and the surface of housing 104.

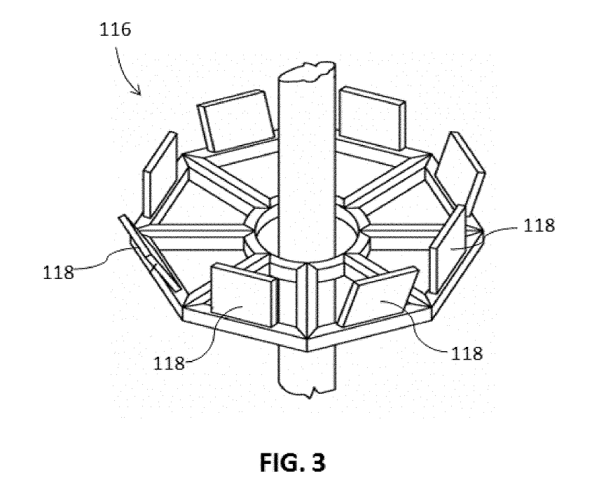

Referring to FIG. 3, an RFID reader 116 is depicted. In one embodiment, RFID reader 116 can be configured to read the RFID tag 106 when the housing 104 is in the open configuration and the RFID tag 106 is exposed free of the Faraday cage. The RFID reader 116 can include a plurality of antennas 118 distributed in or around the retail space. Embodiments of an RFID reader 116 are disclosed in U.S. Pat. No. 8,669,915 (assigned to Wal-Mart Stores, Inc.), the contents of which are incorporated by reference herein. In one embodiment, multiple RFID readers 116 can be distributed and employed throughout the retail environment.

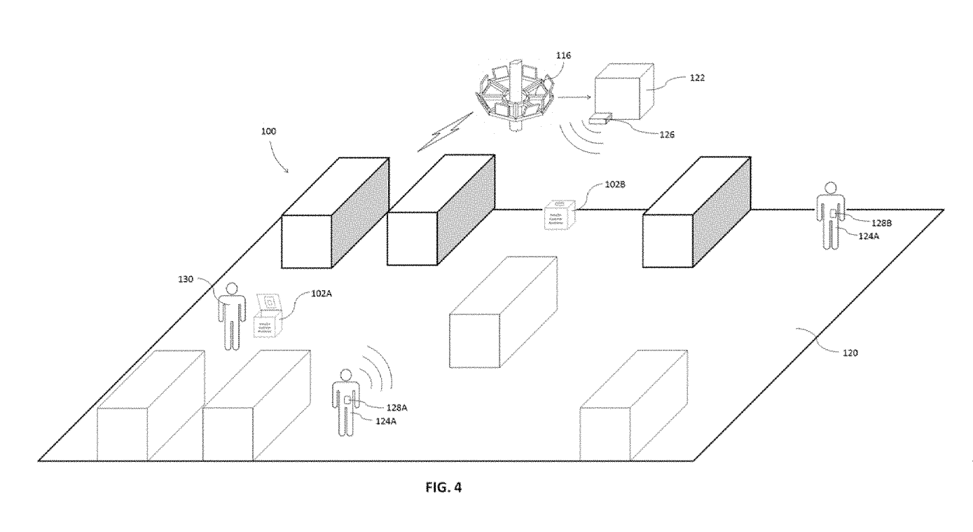

Referring to FIG. 4, a retail space 120 including a customer assistance request system 100 is depicted. The customer assistance request system can include at least one customer assistance kiosk 102A/B, and RFID reader 116 and a communication system 122. The communication system 122 can be in electrical communication with the RFID reader 116. The communication system 122 can be configured to receive the read RFID tag number from the RFID reader 116. Additional information, such as location information, can accompany the RFID tag number, when it is communicated from the RFID reader 116 to the communication system 122.

With the RFID tag number, the communication system 122 can identify location of the customer assistance kiosk 102A. In one embodiment, the communications system 122 includes a database configured to store a list of the RFID tag numbers associated with the deployed customer assistance kiosks 102A/B and their relative positions within the retail 120. Thereafter, when the RFID tag number is communicated to the communication system 122, the communication system 122 can query the database to determine a location of the customer assistance kiosk 102A. For example, the database could indicate that RFID tag #123 is associated with customer assistance kiosk #ABC, which is located in the toy department.

In another embodiment, the communication system 122 uses information from the one or more RFID tag readers 116 to determine the location of the customer assistance kiosk 102A. For example, location can be inferred from the location of at least one of the plurality of antennas 118 that read the RFID tag number, a location of the RFID reader 116 that read the RFID tag number, a direction of a signal received by the at least one of the plurality of antennas 118 that read the RFID tag number, a strength of a signal received by one of the plurality of antennas 118 that read the RFID tag number, and/or a timing of a signal received by at least one of the plurality of antennas 118 that read the RFID tag number. In one embodiment, information from several of the antennas 118 and/or RFID readers 116 can be combined to determine the location of the customer assistance kiosk 102A.

After location of the customer assistance kiosk 102A, the communication system 122 can be configured to issue a notification comprising the identified location of the customer assistance kiosk 102A. In one embodiment, the notification can include the RFID tag number. In one embodiment, the issued notification can be sent to one or more employees 124, or via an employee communication system 126, which can be in electrical communication with the communication system 122. In one embodiment, the issued notification can be sent to a communication device 128A of the employee 124A determined to be closest to the identified location of the customer assistance kiosk 102A and the associated customer 130.

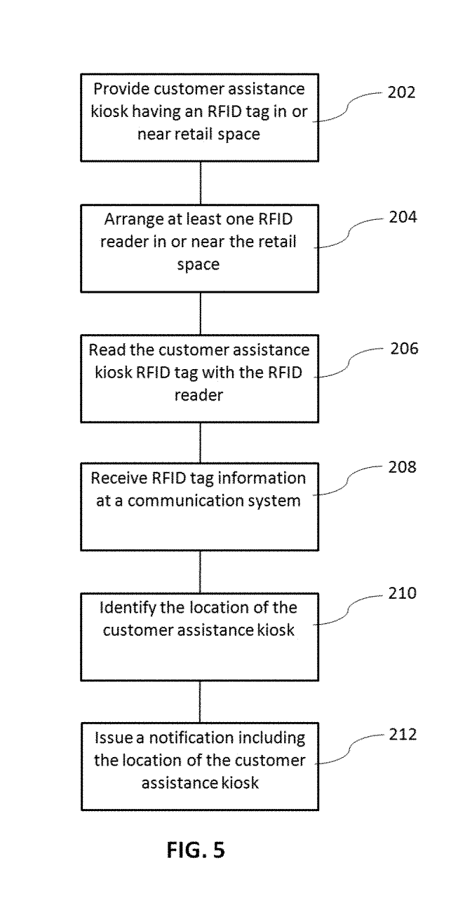

Referring to FIG. 5, at 202 a customer assistance kiosk 102 is provided in or near a retail space 120. The customer assistance kiosk 102 can comprise a housing 104 having an open configuration and a closed configuration, wherein the housing forms a Faraday cage in the closed configuration. An RFID tag 106 having an RFID tag number can be arranged within the housing 104, such that the RFID tag 106 is exposed free of the Faraday cage when the housing 104 is in the open configuration.

At 204, at least one RFID reader 116 is arranged in or near the retail space 120. At 206, the RFID tag reader 116 reads the RFID tag number from the RFID tag 106 when the housing 104 is in the open configuration in the RFID tag 106 is exposed free of the Faraday cage. At 208, the read RFID tag number is communicated to a communication system 122 from the RFID reader 116. At 210, the communication system 122 determines a location of the customer assistance kiosk 102A corresponding to the read RFID tag number. At 212, the communication system 122 issues a notification to one or more employee 124A identifying the location of the at least one customer assistance kiosk 102A comprising the read RFID tag number.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the subject matter hereof may comprise fewer features than illustrated in any of the individual embodiments described above. The embodiments described herein are not meant to be an exhaustive presentation of the ways in which the various features of the subject matter herein may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A customer assistance request system for use in or proximate to a retail space and comprising:
at least one customer assistance kiosk comprising:
a housing having an open configuration and a closed configuration, the housing forming a Faraday cage in the closed configuration, and
a radio frequency identification (RFID) tag having an RFID tag number and being arranged in the housing such that the RFID tag is exposed free of the Faraday cage when the housing is in the open configuration;
an RFID reader configured to read the RFID tag number from the RFID tag when the housing is in the open configuration and the RFID tag is exposed free of the Faraday cage; and
a communication system communicatively coupled with the RFID reader and configured to receive the read RFID tag number from the RFID reader, identify a location of the customer assistance kiosk corresponding to the read RFID tag number, and issue a notification comprising the identified location of the at least one customer assistance kiosk comprising the read RFID tag number.

2. The customer assistance request system of claim 1, wherein the housing comprises a lid having an open position and a closed position, wherein the housing is in the open configuration when the lid is in the open position, and wherein the housing is in the closed configuration when the lid is in the closed position.

3. The customer assistance request system of claim 2, wherein the housing comprises a push button, wherein pushing the push button moves the lid from the closed position to the open position, thereby exposing the RFID tag.

4. The customer assistance request system of claim 3, wherein the RFID tag is mechanically coupled to the lid such that the RFID tag moves from a first position when the lid is in the closed position to a second position when the lid is in the open position.

5. The customer assistance request system of claim 4, wherein a neutral dielectric material is mechanically coupled to the lid, and the RFID tag is mechanically coupled to the neutral dielectric material.

6. The customer assistance request system of claim 4, wherein the RFID tag is suspended from the lid.

7. The customer assistance request system of claim 6, wherein the RFID tag is suspended from the lid by flexible string or cord.

8. The customer assistance request system of claim 1, wherein the housing comprises a metal material.

9. The customer assistance request system of claim 1, further comprising:
a database comprising a matched list of a location of each of the at least one customer assistance kiosk and the RFID tag number of the RFID tag in the housing of the at least one customer assistance kiosks,
wherein the communication system is communicatively coupled with the database and is configured to identify the location of the customer assistance kiosk from the read RFID tag number and the matched list in the database.

10. The customer assistance request system of claim 1, wherein the RFID reader comprises a plurality of antennas distributed in or around the retail space, and wherein the communication system is configured to identify the location of the customer assistance kiosk from at least one of: a location of at least one of the plurality of antennas that read the RFID tag number, a location of the RFID reader that read the RFID tag number, a direction of a signal received by at least one of the plurality of antennas that read the RFID tag number, a strength of a signal received by at least one of the plurality of antennas that read the RFID tag number, or a timing of a signal received by at least one of the plurality of antennas that read the RFID tag number.

11. The customer assistance request system of claim 1, wherein the issued notification is sent to or via an employee communication system.

12. The customer assistance request system of claim 11, wherein the issued notification is sent to a communication device of an employee determined to be proximate the identified location.

13. A method of identifying when and where a retail customer needs assistance in or proximate to a retail space, comprising:
providing at least one customer assistance kiosk in or near the retail space, the at least one customer assistance kiosk comprising a housing having an open configuration and a closed configuration, the housing forming a Faraday cage in the closed configuration, and a radio frequency identification (RFID) tag having an RFID tag number and being arranged in the housing such that the RFID tag is exposed free of the Faraday cage when the housing is in the open configuration;
arranging at least one RFID reader in or near the retail space;
reading, by the at least one RFID reader, the RFID tag number from the RFID tag when the housing is in the open configuration and the RFID tag is exposed free of the Faraday cage;
receiving, by a communication system communicatively coupled with the RFID reader, the read RFID tag number from the RFID reader;
identifying, by the communication system, a location of the customer assistance kiosk corresponding to the read RFID tag number; and
issuing, by the communication system, a notification comprising the identified location of the at least one customer assistance kiosk comprising the read RFID tag number.

14. The method of claim 13, wherein providing at least one customer assistance kiosk comprises providing a push button on the housing, such that pushing the push button causes the housing to move to the open configuration and exposes the RFID tag.

15. The method of claim 14, wherein providing at least one customer assistance kiosk comprises mechanically coupling the RFID tag to a lid of the housing such that the RFID tag moves from a first position when the lid is in the closed position and the housing is in the closed configuration to a second position when the lid is in the open position and the housing is in the open position, wherein pushing the push button causes the lid to move to the open position.

16. The method of claim 13, wherein the identifying comprises:
checking a database comprising a matched list of a location of each of the at least one customer assistance kiosk and the RFID tag number of the RFID tag in the housing of the at least one customer assistance kiosks, and
identifying the location of the customer assistance kiosk from the read RFID tag number and the matched list in the database.

17. The method of claim 13, wherein the RFID reader comprises a plurality of antennas, and wherein the identifying comprises:
using at least one of a location of at least one of the plurality of antennas that read the RFID tag number, a location of the RFID reader that read the RFID tag number, a direction of a signal received by at least one of the plurality of antennas that read the RFID tag number, a strength of a signal received by at least one of the plurality of antennas that read the RFID tag number, or a timing of a signal received by at least one of the plurality of antennas that read the RFID tag number.

18. The method of claim 13, further comprising receiving the issued notification by an employee communication device.

19. The method of claim 18, wherein the issued notification was sent to the employee communication device because the employee communication device was determined to be proximate the identified location.
